(19) United States
(12) Patent Application Publication
(10) Pub. No.: US 2017/0326585 A1
(43) Pub. Date: Nov. 16, 2017

(54) MULTI-LAYERED ARTICLE

(71) Applicant: SOLVAY SPECIALTY POLYMERS ITALY S.P.A., Bollate (IT)

(72) Inventors: Pasqua COLAIANNA, Milano (IT); Amelia MENNELLA, Torre del Greco (IT); Serena CARELLA, Parabiago (IT)

(21) Appl. No.: 15/535,402

(22) PCT Filed: Dec. 16, 2015
(86) PCT No.: PCT/EP2015/079956

§ 371 Date: Jun. 12, 2017

(30) Foreign Application Priority Data
Dec. 16, 2014 (EP) 14198319.7

(51) Int. Cl. B05D 5/08; B05D 7/00; B05D 7/14; B05D 5/00

(52) U.S. Cl. CPC B05D 5/083; B05D 7/58; B05D 7/54; B05D 7/14; B05D 5/086; B05D 7/00; B05D 5/00

(57) ABSTRACT

The present invention relates to a multi-layered article comprising a metal part and a coating, having outstanding adhesion between said coating and said metal part, even in severe environment conditions, such as marine environment, high pressure and high temperature.

### CROSS REFERENCE TO RELATED APPLICATIONS

This application claims priority from European application No. 14198319.7, filed on 16 Dec. 2014, the whole content of this application being incorporated herein by reference for all purposes.

### TECHNICAL FIELD

The present invention relates to a multi-layered article comprising a metal part and a coating, having outstanding adhesion between said coating and said metal part, even in severe environment conditions, such as marine environment, high pressure and high temperature.

### BACKGROUND ART

Off-shore pipelines, used to pump oil and gas ashore from off-shore drilling rigs and terminals, are required to be capable of withstanding very high internal pressures and temperatures and are therefore typically made of metals such as iron and steel.

However, among major issues encountered with metal pipelines in general, and off-shore pipelines in particular, is the problem of corrosion due to the marine environment, which causes a deterioration of the material and, as a consequence, reduces its thermal and chemical resistance.

Tetrafluoroethylene/perfluoro(alkyl vinyl ether) copolymers, commercially known as PFA, are melt-processable polymers characterized by a high melting point, high thermal stability, chemical inertness and low dielectric constant, as well as good mechanical properties at room and elevated temperature. Generally, a commercial PFA polymer has a melting point of approximately 305° C. and a continuous use temperature of about 260° C., wherein the parameter of continuous use temperature indicates the highest operating temperature the polymer can continuously withstand.

Therefore, PFA polymers are widely used as coatings in industrial applications that require a high operating temperature and possibly a chemically aggressive environment, such as coatings of off-shore pipelines. PFA polymers provide anti-stick properties and thermal and chemical resistance, reducing the access of water, oxygen and carbon dioxide to the metal, thus making negligible the corrosion rate.

However, due to their anti-stick properties, PFA polymers show low adhesion to the metal. Thus, to achieve a good adhesion between PFA polymer coatings and the underlying substrate, a primer (also referred to as binder) is required.

For example, JP 2000-076675 (NTN TOYO BEARING CO. LTD.) discloses a metal cylinder coated with a layer made from a coating composition comprising a fluororesin powder, optionally using a binder such as an epoxy resin, a phenol resin, a poly-amide-imide (PAI) or poly-imide (PI). The coating composition comprising the fluororesin powder, alone or together with the binder, is dispersed or dissolved in a solvent. Also, J P 2003-336005 discloses a composition for coating a bending part of a shaped article, said composition comprising an epoxy resin, metal flakes and a lubricating compound selected from a fluorine resin (such as tetrafluoroethylene—TFE, polytetrafluoroethylene—PTFE, and PFA) or molybdenum disulphide, tungsten disulphide and boron nitride. The coating composition is formulated in a solvent. More recently, WO 2011/041527 discloses a coating composition that can be used as anti-corrosion coating on metal surfaces, said composition comprising—as a weight percent of solids based on the total weight of solids: 1-35 wt. % of a fluoropolymer, 1-70 wt. % of an epoxy resin, 5-70 wt. % of a polyamideimide (PAI), optionally 1-40 wt. % of an auxiliary binder and an effective amount solvent, such as non-aqueous solvents or water and an emulsifier, or water and a dispersion agent, or a mixture of one or more non-aqueous solvents and water. FR 2408396 discloses a process for applying fluorinated resins onto smooth metallic surfaces, comprising applying a primer layer comprising an epoxy resin, a phenolic resin or a polyester resin and then a layer comprising a fluorinated resin.

However, despite the use of a primer, harsh conditions of high temperature and/or pressure, which coated metal pipelines are subjected to, in particular in the oil and gas industry, adversely affect the adhesion of the coating to the metal. As a consequence, detachment of the coating from the metal can be observed, resulting in an increased corrosion of the same.

Also, when compositions comprising an organic solvent are used in the manufacturing of the coating, defects, such as voids, can be generated in the coating layer during the step of removal of the solvent. These defects are weaknesses, from which the cathodic disbondment of the coating can start, thus accelerating the corrosion process.

### SUMMARY OF INVENTION

Despite the efforts made in the art, the Applicant perceived that there is still the need of providing protective coatings for metal substrates, which have excellent corrosion resistance and strong adhesion to the metal substrate.

Thus, the Applicant faced the problem to provide an article comprising a metal substrate and a coating layer, wherein outstanding adhesion between said metal substrate and said coating layer is achieved, even in severe environment conditions, such as marine environment, high pressure and/or high temperature.

Thus, in a first aspect, the present invention relates to a multi-layered article comprising:
a metal part having at least one surface [surface (S)];
a first layer [layer (L1)] having a first surface [surface (S1-L1)] directly adhered to said surface (S) and a second surface [surface (S2-L1)], said layer (L1) being made from a first composition [composition (C1)], said composition (C1) comprising at least one epoxy resin [resin (E1)];
a second layer [layer (L2)] having a first surface [surface (S1-L2)] directly adhered to said second surface (S2-L1) of said layer (L1) and a second surface [surface (S2-L2)], said layer (L2) being made from a second composition [composition (C2)], said composition (C2) comprising at least one epoxy resin [resin (E2)] and at least one melt-processable perfluoropolymer [polymer (Pₐ)]
and
optionally, a third layer [layer (L3)] having a first surface [surface (S1-L3)] directly adhered to said second surface (S2-L2) of said layer (L2), and a second surface [surface (S2-L3)], said layer (L3) being made from a third composition [composition (C3)], said composition (C3) comprising at least one melt-processable perfluoropolymer [polymer (P_{b})].

The Applicant has surprisingly found that in the multi-layered article of the present invention a strong adhesion between the metal and the coating formed by layers (L1), (L2) and optionally (L3) is achieved, such that said multi-layered article can resist with no or very little degradation to severe environment conditions.

### DESCRIPTION OF EMBODIMENTS

For the purpose of the present description and of the following claims:
the use of parentheses, for example in expressions like “surface (S)”, “layer (L1)”, etc. has the mere purpose of better distinguishing the symbol or number from the rest of the text and, hence, said parenthesis can also be omitted;
the expression “substantially free of solvent” is intended to mean that any one of composition (C1), composition (C2) and/or composition (C3) comprises less than 1 wt. %, preferably less than 0.5 wt. % and more preferably less than 0.1 wt. % of a solvent, based on the total amount of said composition (C1). The term “solvent” is intended to comprise any apolar solvent and any polar solvent protic or aprotic.

Preferably, said article is in the form of a film or of a shaped article, such as panel, plate, plaque, film, sheet, rods, pipes, cylinders, vessels, containers, wires, cables, and heat-exchanging tubes.

Preferably, said metal part is made of steel, such as stainless steel and carbon steel.

Typically, said composition (C1) can be liquid or solid. Preferably, said composition (C1) is substantially free of solvent. In a preferred embodiment, said composition (C1) is in the form of powder.

Preferably, said composition (C1) comprises at least one resin (E1) and optionally further ingredients.

Suitable epoxy resins (E1) which may be employed in said composition (C1) include, but not limited to, epoxy resins which may be prepared by the condensation of epoxy compounds, such as epichlorohydrin and glycerol dichlorohydrin, with polyhydric-organic compounds such as alcohols; e.g., pentaerythritol; dihydric alcohols, e.g., glycerol; dihydric phenols, e.g., bisphenol A; and trihydric phenols. For example, bisphenol A based epoxy resins, such as epoxy resins prepared by the condensation of bisphenol A and epichlorohydrin, or the diglycidyl ether of bisphenol A, may be employed. Other epoxy resins include epoxidized novolac resins such as epoxy cresol novolacs and epoxy phenol novolacs. Other epoxy resins which may be employed include cycloaliphatic resins in which the epoxide groups are attached directly to the cycloaliphatic portions of the molecule rather than on the alkyl chain.

Preferred resins (E1) which may be employed in said composition (C1) include bisphenol A based epoxy resins and epoxy cresol novolac resins. A preferred bisphenol A based epoxy resin has the following structure:

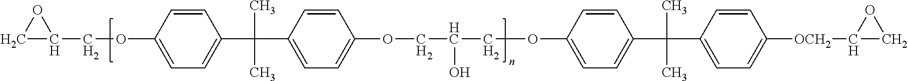

wherein n is from about 2 to about 30.

A preferred epoxy cresol novolac resin has the following structure:

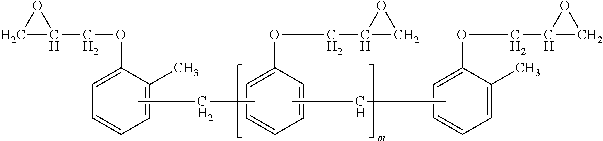

wherein m is from about 5 to about 25.

Said further ingredients can be selected in the group comprising fillers and other additives comprising for example metal oxides, such as titanium dioxide, zinc oxide; pigments; preservatives, such as dapsone; and curing agents, such as amine curing agents.

Examples of fillers which may be employed include, but are not limited to, sulfates, such as for example barium sulphate and calcium sulphate, and silicates, such as for example calcium metasilicate.

Examples of amine curing agents which may be employed include, but are not limited to, polyamidoamines (such as polyamidoamines derived from dimerized linoleic acid and diethylenetriamine); amidoamines (such as amidoamines derived from stearic acid); aliphatic amine adducts; alkylene oxide/polyamine adducts; polyalkylene oxide amines; products of the amination of polypropylene glycol or polyethylene glycol; ketimines; dicyandiamide; and aromatic amines.

Preferably, said composition (C1) comprises said at least one resin (E1) in an amount of from 5 to 45 wt. %, more preferably from 10 to 43 wt. %, and even more preferably from 15 to 40 wt. %, based on the total weight of composition (C1).

Preferably, said composition (C1) comprises said at least one filler in an amount of from 30 to 60 wt. %, more preferably from 35 to 55 wt. %, even more preferably from 40 to 50 wt. %, based on the total weight of composition (C1).

Preferably, said composition (C1) comprises at least one, more preferably at least two and even more preferably at least three other additive(s) disclosed above in an amount of from 0.5 to 45 wt. %, more preferably from 5 to 40 wt. %, and even more preferably from 10 to 35 wt. %, based on the total weight of composition (C1).

An example of composition (C1) which may be employed is a bisphenol A epoxy based powder product manufactured by Azkonobel N.V. and sold under the trade name Interpon® 100 AK123QF.

Typically, said composition (C2) can be liquid or solid. Preferably, said composition (C2) is substantially free of solvent.

In a preferred embodiment, said composition (C2) is in the form of powder. Preferably, the powder comprises particles having a particle size of less than 450 μm. Preferably, said particles have a particle size of at least 1 μm, more preferably of at least 5 μm. The particle size is determined according ISO 13320/1 using light laser diffraction on a sample in form of dried powder.

Preferably, said composition (C2) comprises at least one resin (E2), at least one polymer (Pₐ), optionally at least one oxide of cobalt and optionally further ingredients.

Said at least one resin (E2) is defined as resin (E1) disclosed above with respect to composition (C1). Resin (E2) can be the same as or different from said resin (E1). Preferably resin (E2) is the same as resin (E1).

The expression “melt-processable” is intended to mean that polymer (Pₐ) can be processed (i.e. fabricated into shaped articles such as films, fibers, tubes, fittings, wire coatings and the like) by conventional melt extruding, injecting or casting means. This generally requires that the melt viscosity at the processing temperature be no more than 10⁸ Pa×sec, preferably from 10 to 10⁶ Pa×sec. The melt-viscosity of polymer (Pₐ) can be measured according to ASTM D-1238, using a cylinder, orifice and piston tip made of a corrosion-resistant alloy, charging a sample into the 9.5 mm inside diameter cylinder which is maintained at a temperature exceeding the melting point, extruding the sample through a 2.10 mm diameter, 8.00 mm long square-edged orifice under a load (piston plus weight) of 5 Kg. The melting viscosity (or melt flow index, MFI) is expressed as extrusion rate in grams per minute or alternatively can be calculated in “Pa×sec” from the observable extrusion rate in grams per minute.

Preferably, polymer (Pₐ) of the present invention is semi-crystalline. Within the present description and in the following claims, the term “semi-crystalline” is intended to denote a polymer having a heat of fusion of more than 1 J/g when measured by Differential Scanning calorimetry (DSC) at heating rate of 10°/min, according to ASTM D-3418. Preferably, polymer (Pₐ) has a heat of fusion of at most 35 J/g, more preferably of at most 20 J/g, and even more preferably from 15 to 5 J/g.

The term “perfluoropolymer” is intended to indicate a polymer consisting essentially of recurring units derived from at least one perfluorinated monomer. The expression “perfluorinated monomer” is intended to indicate fully fluorinated monomers, which are free of hydrogen atoms. The expression “consisting essentially of” is intended to indicate that minor amounts of end chains, defects, irregularities and monomer rearrangements are tolerated in the perfluoropolymer. The expression “at least one perfluorinated monomer” is intended to indicate that the perfluoropolymer contains recurring units derived from one or more perfluorinated monomers.

Non-limitative examples of suitable perfluorinated monomers are notably:
C₂-C₈ perfluoroolefins, such as tetrafluoroethylene (TFE) and hexafluoropropene (HFP);
chloro- and/or bromo- and/or iodo-C₂-C₆ fluoroolefins, such as chlorotrifluoroethylene (CTFE);
CF₂═CFOR_{f1}, wherein R_{f1} is a C₁-C₆ perfluoroalkyl group, such as CF₃, C₂F₅, C₃F₇, or a group of formula —CFOCF₂OR_{f2} wherein R_{f2} is a C₁-C₆ perfluoroalkyl group, e.g. CF₃, C₂F₅, C₃F₇, a cyclic C₅-C₆ perfluoroalkyl group, or a C₁-C₁₂ (per)fluorooxyalkyl group comprising one or more ether groups, such as —C₂F₅—O—CF₃;
perfluorodioxoles of formula:

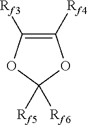

wherein each of R_{f3}, R_{f4}, R_{f5}, R_{f6}, equal of different each other, is independently a fluorine atom, a C₁-C₆ perfluoroalkyl group, optionally comprising one or more oxygen atom, e.g. —CF₃, —C₂F₅, —C₃F₇, —OCF₃, —OCF₂CF₂OCF₃.

Preferably, polymer (Pₐ) is chosen among tetrafluoroethylene (TFE) copolymers comprising recurring units derived from TFE and recurring units derived from at least one perfluorinated monomer different from TFE [co-monomer (F)]. The term “copolymer” is intended to indicate also TFE terpolymer and TFE tetrapolymer, comprising recurring units derived from TFE and from two and three perfluorinated monomers different from TFE, respectively.

More preferably, said at least one co-monomer (F) is selected from the group consisting of:
C₂-C₈ perfluoroolefins, such as hexafluoropropene (HFP);
CF₂═CFOR_{f1}, wherein R_{f1} is a C₁-C₆ perfluoroalkyl group, such as CF₃, C₂F₅, C₃F₇, a cyclic C₅-C₆ perfluoroalkyl group, or a C₁-C₁₂ (per)fluorooxyalkyl group comprising one or more ether groups, such as —C₂F₅—O—CF₃;
perfluorodioxoles of formula:

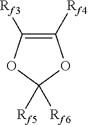

wherein each of R_{f3}, R_{f4}, R_{f5}, R_{f6}, equal of different each other, is independently a fluorine atom, a C₁-C₆ perfluoroalkyl group, optionally comprising one or more oxygen atom, e.g. —CF₃, —C₂F₅, —C₃F₇, —OCF₃, —OCF₂CF₂OCF₃; and
combinations thereof.

Still more preferably, said at least one co-monomer (F) is selected from the group consisting of:
hexafluoropropene (HFP);
CF₂═CFOR_{f1}, wherein R_{f1} is selected from:
(a) —CF₃, —C₂F₅, and —C₃F₇—, namely, perfluoromethylvinylether (PMVE of formula CF₂═CFOCF₃), perfluoroethylvinylether (PEVE of formula CF₂═CFOC₂F₅), perfluoropropylvinylether (PPVE of formula CF₂═CFOC₃F₇), and combinations thereof;
(b) —C—F₂OR_{f2}, wherein R_{f2} is a linear or branched C₁-C₆ perfluoroalkyl group, cyclic C₅-C₆ perfluoroalkyl group, a linear or branched C₂-C₆ perfluoroxyalkyl group; preferably, R_{f2} is —CF₂CF₃ (MOVE1), —CF₂CF₂OCF₃ (MOVE2), or —CF₃ (MOVE3); and
combinations thereof.

Preferably, polymer (Pₐ) comprises at least 0.6 wt. %, preferably at least 0.8 wt. %, more preferably at least 1 wt. % of recurring units derived from said at least one co-monomer (F).

Preferably, polymer (Pₐ) comprises at most 40 wt. %, preferably at most 30 wt. %, more preferably at most 25 wt. % of recurring units derived from said at least one co-monomer (F).

Good results have been obtained when polymer (Pₐ) is a TFE copolymer comprising from 1 wt. % to 30 wt. %, more preferably from 5 wt. % to 25 wt. %, of recurring units derived from said at least one co-monomer (F), wherein said co-monomer (F) is selected from PMVE, PEVE, PPVE, MOVE1, MOVE2 and combinations thereof.

In an alternative embodiment, said polymer (Pₐ) can comprise one or molar polar functional groups [polymer (Pₐ-F)].

Said polymer (Pₐ-F) preferably comprises one or more functional groups in an amount of from 8 to 200 mmoles/Kg, more preferably from 10 to 100 mmoles/Kg of said polymer (Pₐ-F).

Said polymer (Pₐ-F) preferably comprises one or more polar functional groups selected from the group consisting of carboxylic groups in its acid, acid halide or salt form; sulfonic groups in its acid, acid halide or salt form; epoxide groups; silyl groups, alkoxysilane groups; hydroxyl groups; and isocyanate groups. Carboxylic groups in acid halide form are preferably acyl fluoride groups.

Said polymer (Pₐ-F) more preferably comprises one or more polar functional groups selected from the group consisting of carboxylic groups in its acid, acid halide or salt form; and sulfonic groups in its acid, acid halide or salt form.

The identification and quantitative determination of the polar functional groups in the polymer (Pₐ-F) is generally carried out by commonly known techniques such as IR and NMR spectroscopies.

Said polymer (Pₐ-F) can be manufactured for example, according to a first embodiment, by irradiation of at least one polymer (Pa) as defined above using wither a proton source or an electron source such as beta rays, gamma rays or X rays.

Irradiation is advantageously carried out at an irradiation dose of from 0.1 MRad to 50 MRad.

Irradiation is typically carries out under air atmosphere or under vacuum. Alternatively, irradiation may be performed under modified atmosphere, e.g. under an inert gas such as N₂.

Said polymer (Pₐ-F) can be manufactured for example, according to a second embodiment, by polymerization of:
at least one perfluorinated monomer selected from:
C₃-C₈ perfluoroolefins;
CF₂═CFOR_{f1} wherein R_{f1} is as defined above
with at least one functional fluoro-alkylvinylether of formula CF₂═CFOY₀ wherein Y₀ is a C₁-C₁₂ alkyl or (per)fluoroalkyl group, or a C₁-C₁₂ oxyalkyl or a C₁-C₁₂ (per)fluorooxyalkyl group, said Y₀ group comprising a carboxylic groups in its acid, acid halide or salt form or a sulfonic group in its acid, acid halide or salt form.

Polymer (Pₐ-F) can be used in said composition (C2) alone or in admixture with at least one polymer (Pₐ) that does not comprise functional groups.

In a preferred embodiment, said polymer (Pₐ) is a TFE copolymer consisting essentially of:

(I) from 5 wt. % to 25 wt. % of recurring units derived PMVE; and
(II) recurring units derived from TFE, in such an amount that the sum of the percentages of the recurring units (I) and (II) is equal to 100% by weight.

In another preferred embodiment, said polymer (Pₐ) is a TFE copolymer consisting essentially of:

(I) from 5 wt. % to 25 wt. % of recurring units derived from PMVE;
(II) from 0.5 wt. % to 5 wt. % of recurring units derived from PPVE; and
(III) recurring units derived from TFE, in such an amount that the sum of the percentages of the recurring units (I), (II) and (III) is equal to 100% by weight.

In still another preferred embodiment, said polymer (Pₐ) is a TFE copolymer consisting essentially of:

(I) from 1 wt. % to 25 wt. % of recurring units derived PPVE; and
(II) recurring units derived from TFE, in such an amount that the sum of the percentages of the recurring units (I) and (II) is equal to 100% by weight.

Suitable polymers (Pₐ) for the present invention are commercially available from Solvay Specialty Polymers Italy S.p.A. under the trade name of HYFLON® PFA P and M series and HYFLON® MFA.

Preferably, said at least one oxide of cobalt is selected from the group comprising cobaltic oxide (Co₂O₃), cobaltous oxide (CoO), cobalto-cobaltic oxide (Co₃O₄), or a mixture of any two or three forms above. Preferably, the oxide of cobalt in composition (C2) is cobaltic oxide (Co₂O₃).

Other ingredients suitable for said composition (C2) are selected in the group comprising fillers and other additives selected in the group comprising metal oxides, such as titanium dioxide, zinc oxide; pigments; preservatives, such as dapsone; and curing agents, such as amine curing agents.

Suitable fillers and amine curing agents can be selected from those listed above with respect to composition (C1).

Preferably, said composition (C2) comprises from 0.01 to 20.25 wt. %, more preferably from 0.25 to 17.2 wt. %, and even more preferably from 1 to 14 wt. % of said resin (E2) based on the total weight of said composition (C2).

Preferably, said composition (C2) comprises from 40 to 99.99 wt. %, more preferably from 50 to 95 wt. %, and even more preferably from 65 to 90 wt. % of said polymer (Pₐ) based on the total weight of said composition (C2).

Preferably, said composition (C2) further comprise at least one filler in an amount of from 0.3 to 27 wt. %, more preferably from 1.75 to 22 wt. %, and even more preferably from 4 to 17.5 wt. % based on the total weight of said composition (C2).

Preferably, said composition (C2) further comprise other additives as listed above, in an amount of from 0.0001 to 6.75 wt. %, more preferably from 0.05 to 4.8 wt. %, and even more preferably from 0.05 to 3.5 wt. % based on the total weight of said composition (C2).

When present in said composition (C2), said oxide of cobalt is in an amount of from 0.05 to 10 wt. %, preferably from 0.1 to 8 wt. %, and more preferably from 0.5 to 6 wt. % based on the total weight of said composition (C2).

Good results have been obtained with a composition (C2) comprising the abovementioned Interpon® 100—AK123QF epoxy based powder, polymer (Pₐ) as defined above, and optionally Co₂O₃.

Thickness of layer (L1) and layer (L2) is not particularly limited. Preferably, the total thickness of said layer (L1) and said layer (L2) is of from 10 to 1200 μm, more preferably of from 50 to 1000 μm, and even more preferably of from 200 to 800 μm.

Advantageously, said composition (C3) is substantially free of solvent.

In a preferred embodiment, said composition (C3) is in the form of powder.

Preferably, said powder comprises particles having a particle size below 300 μm, more preferably below 200 μm measured according to ISO 13320/1 using light laser diffraction on dried powder. More preferably, said particles have a particle size between 1 and 195 μm, even more preferably between 5 and 150 μm.

Preferably, said composition (C3) comprises at least one polymer (P_{b}), and optionally further ingredients.

Said polymer (P_{b}) is defined as polymer (Pₐ) disclosed above with respect to composition (C2). Polymer (P_{b}) can be the same as or different from said polymer (Pₐ). In a preferred embodiment, said polymer (P_{b}) is the same as polymer (Pₐ).

Suitable further ingredients can be selected for example from organic and/or inorganic filers, such as carbon black, mica and polyphenylene sulfone-based additives (PPSO2), which is commercially available under the trademark Ceramer®.

Preferably, said composition (C3) comprises said polymer (P_{b}) in an amount of from 50 to 100 wt. % based on the total weight of said composition (C3).

Preferably, said composition (C3) comprises at least one of said further ingredients in an amount of from 0.1 to 50 wt. % based on the total weight of said composition (C3).

Thickness of layer (L3) is not particularly limited. Preferably, said layer (L3) has a thickness of from 30 to 1500 μm, more preferably of from 100 to 1200 μm, and even more preferably of from 300 to 1000 μm.

Optionally, the multi-layered article according to the present invention can comprise a further layer [layer (L4)] directly adhered to said surface (S2-L3) of said layer (L3), said layer (L4) being made from a fourth composition [composition (C4)], said composition (C4) comprising at least one perfluoropolymer [polymer (P_{c})] and optionally further ingredients.

Advantageously, said polymer (P_{c}) is defined as polymer (Pₐ) disclosed above with respect to composition (C2).

As will be apparent to those skilled in the art, the multi-layered article according to the present invention can comprise further layers (i.e., layer (L5), layer (L6) and so on) comprising at least one perfluoropolymer as defined above.

The multi-layered article according to the present invention can be manufactured by a method comprising the following steps:

(a) providing an article comprising a metal part, said metal part having at least one surface [surface (S)];
(b) applying a first composition (C1) comprising at least one resin (E1), so as to provide a layer (L1) having a first surface (S1-L1) directly adhered to said surface (S) and a second surface (S2-L1);
(c) applying a second composition (C2) comprising at least one resin (E2) and at least one melt-processable polymer (Pₐ), so as to provide a layer (L2) having a first surface (S1-L2) directly adhered to said second surface (S2-L1) and a second surface (S2-L2); and
(d) optionally, applying a third composition (C3) comprising at least one polymer (P_{b}), so as to provide a layer (L3) having a first surface (S1-L3) directly adhered to said second surface (S2-L2), and a second surface (S2-L3).

Advantageously, as disclosed above, any one of compositions (C1), (C2) and (C3) is substantially free of solvent, so as to reduce the formation of defects during the coating and also to have a low environmental impact.

In a preferred embodiment, compositions (C1), (C2) and (C3) are in the form of powder.

Said composition (C1) can be prepared for example by providing said at least one resin (E1) as disclosed above, and optionally mixing said resin (E1) with other ingredients in suitable amounts, as disclosed above. Said mixing can be performed in a suitable powder mixer, such as for example vertical mixer or horizontal mixer.

Typically, said composition (C2) is prepared by mixing together said at least one resin (E2), said at least one polymer (Pₐ), optionally said cobalt oxide and optionally further ingredients in suitable amounts, as disclosed above. The mixing step is preferably performed as disclosed above with respect to composition (C1).

Typically, said composition (C3) is prepared by for example by providing said polymer (P_{b}) as disclosed above, and optionally mixing said polymer (P_{b}) with other ingredients in suitable amounts, as disclosed above. The mixing step is preferably performed as disclosed above with respect to composition (C1).

Under step (a), said article can be any article comprising at least one metal part, as defined above.

Advantageously, the surface of the metal part should provide anchoring properties for the coating layers.

To this aim, in order to remove dirty and contaminants, step (a-I) of cleaning the surface of said metal part may be advantageously performed after step (a) and before step (b). Said step (a-I) is preferably performed using a suitable solvent, such as alcohols and inorganic solvents, and optionally heating at a temperature of from 60° C. to 300° C.

With the aim to further improve the adhesion, step (a-II) of treating the surface of said metal part to provide a roughened surface may be advantageously performed after step (a) or step (a-I) and before step (b). Said step (a-II) is preferably performed by abrasive blasting, including wet abrasive blasting, hydro-blasting, micro-abrasive blasting and the like.

Also, step (a-III) of heating and/or step (a-IV) of rinsing the surface of the metal panel can be performed after step (a-II) and before step (b).

Step (a-III) may be performed at a temperature of from 60° C. to 380° C., for a time of from 5 to 45 minutes.

Step (a-IV) may be performed with suitable organic or mineral solvents, such as for example H₃PO₄.

In a preferred embodiment, step (a-III) may be performed a first time after step (a-II) and before step (a-IV), at a temperature between 60° C. and 100° C., and a second time after step (a-IV) and before step (b), at a temperature between 200° C. and 380° C.

Preferably, step (b) is performed by suitable techniques, such as for example electrostatic spray.

Typically, electrostatic spray is performed by means of an electrostatic spray gun, which uses the principle of electrophoresis that electrically polarized particles are attracted to a grounded or oppositely charged surface.

When electrostatic spray is used, output settings can be properly selected by the skilled person. Good results have been obtained by working between 10 and 60 kV and between 5 μA and 40 μA, using OptiFlex® L spray gun from ITW Gema AG.

Typically, the thickness of the layer obtained by electrostatic spray is from 10 to 1500 μm, more preferably from 50 to 1200 μm.

Preferably, step (c) is performed by suitable techniques, such as for example electrostatic spray, as disclosed above.

After the application of said composition (C2), step (c) may optionally comprise heating the article thus obtained.

The skilled person can determine the time and the temperature of heating, depending on the processing temperature of polymer (Pₐ). For example, when using polymers (Pₐ) as defined above, heating is advantageously performed between 220° C. and 280° C., for a time from 5 to 30 minutes.

Optionally, in order to achieve a desired thickness of layer (L2), step (c) can be repeated, for example two or three times, before optional step (d).

Preferably, step (d) is performed by suitable techniques, such as for example electrostatic spray, as disclosed above, and compression molding.

When electrostatic spray is used, after spraying the application of composition (C3), step (d) comprises heating the article thus obtained.

The skilled person can determine the time and the temperature of heating, depending on the processing temperature of polymer (P_{b}). For example, when polymer (P_{b}) is the same polymer (Pₐ) as defined above, heating is performed in the same conditions disclosed above with respect to step (c).

Optionally, in order to achieve a desired thickness of layer (L3), step (d) can be repeated, for example two or three times.

When compression molding is used, composition (C3) is first pre-heated or molded, to obtain a plate made from composition (C3).

Then, said plate is placed onto the surface of the metal part of the article in a press, heated at a suitable temperature and then pressed. The temperature and pressure can be selected by the skilled person, depending on polymer (P_{b}) used. Good results have been obtained by working at a temperature between 250° C. and 400° C. and at a hydrostatic pressure between 50 and 100 bar.

Typically, the thickness of layer obtained by compression molding is up to 3000 μm, for example from 100 to 2000 μm, more preferably from 200 to 1500 μm.

Optionally, the method according to the present invention can further comprise step (e) of applying a fourth composition (C4) at least one perfluoropolymer [polymer (P_{c})] and optionally further ingredients, so as to provide a layer (L4) having a first surface (S1-L4) directly adhered to said second surface (S2-L3) of said layer (L3).

Preferably, said step (e) is performed by electrostatic spray or by compression molding, as disclosed above.

If the multi-layered article comprises further layers (i.e. layer (L5), layer (L6) and so on) as disclosed above, said further layers may be applied by electrostatic spray or by compression molding, as disclosed above.

Should the disclosure of any patents, patent applications and publications which are incorporated herein by reference conflict with the description of the present application to the extent that it may render a term unclear, the present description shall take precedence.

The invention will be herein after illustrated in greater detail by means of the following Examples, which are merely illustrative and are by no means to be interpreted as limiting the scope of the invention.

### EXAMPLES

### Materials:

Copolymer A: Hyflon® TFE/PMVE copolymer, in powder form, containing 17 wt. % of PMVE based on the total weight of the copolymer—melting point (Tₘ) of about 220° C.—melt flow index (MFI) of 26.1 g/10 min measured in accordance with modified ASTM D-1238, at 300° C. with 5 Kg of load—average particle size in the range between 20 and 80 μm measured by light laser diffraction according to ISO 13320/1. Copolymer B: Hyflon® MFA990 TFE/PMVE/PPVE terpolymer, in powder form, containing 12 wt. % of PMVE and 2 wt. % of PPVE—Tₘ of about 245° C.—MFI of 350 g/10 min measured in accordance with ASTM D-1238 at 372° C./5 Kg—average particle size in the range between 20 and 80 μm measured by light laser diffraction according to ISO 13320/1. Interpon® 100—AK123QF (herein after referred to as “AK123QF”) supplied by Azkonobel: bisphenol A epoxy based powder formulation. Cobalt oxide (Co₂O₃) from Sigma-Aldrich.

### Example 1—Preparation of the Multi-Layered Articles

Multi-layered articles (hereinafter “samples”) No. 1 to 10 comprising a carbon steel panel or a stain steel panel as metal part (hereinafter “metal panels”) and layers L1, L2 and L3 were prepared as detail below.

Layers L1, L2 and L3 for each sample were obtained using compositions C1, C2 and C3, respectively, as disclosed in the following Table 1:

TABLE 1

| Sample | | | Composition |
|---|---|---|---|
| No. | Composition C1 | Composition C2 | C3 |
| 1C(*) | AK123QF 100 wt. % | — | Copolymer A |
| | | | 100 wt. % |
| 2C(*) | AK123QF 25 wt. % | — | Copolymer A |
| | Copolymer A | | 100 wt. % |
| | 75 wt. % | | |
| 3C(*) | AK123QF 25 wt. % | — | Copolymer A |
| | Copolymer A | | 100 wt. % |
| | 72 wt. % | | |
| | Co oxide 3 wt. % | | |
| 4 | AK123QF 100 wt. % | AK123QF 10 wt. % | Copolymer A |
| | | Copolymer A | 100 wt. % |
| | | 89 wt. % | |
| | | Co oxide 1 wt. % | |
| 5 | AK123QF 100 wt. % | AK123QF 30 wt. % | Copolymer A |
| | | Copolymer A | 100 wt. % |
| | | 67 wt. % | |
| | | Co oxide 3 wt. % | |
| 6C(*) | AK123QF 25 wt. % | — | Copolymer B |
| | Copolymer B 75 wt. % | | 100 wt. % |
| 7 | AK123QF 100 wt. % | AK123QF 10 wt. % | Copolymer B |
| | | Copolymer B 89 wt. % | 100 wt. % |
| | | Co oxide 1 wt. % | |
| 8 | AK123QF 100 wt. % | AK123QF 10 wt. % | Copolymer B |
| | | Copolymer B 85 wt. % | 100 wt. % |
| | | Co oxide 5 wt. % | |
| 9 | AK123QF 100 wt. % | AK123QF 10 wt. % | Copolymer B |
| | | Copolymer B 89 wt. % | 100 wt. % |
| | | Co oxide 5 wt. % | |
| 10 | AK123QF 100 wt. % | AK123QF 30 wt. % | Copolymer B |
| | | Copolymer B 67 wt. % | 100 wt. % |
| | | Co oxide 3 wt. % | |
| 11 | AK123QF 100 wt. % | AK123QF 10 wt. % | Copolymer B |
| | | Copolymer B 90 wt. % | 100 wt. % |
| 12C(*) | AK123QF 100 wt. % | AK123QF 70 wt. % | Copolymer B |
| | | Copolymer B 30 wt. % | 100 wt. % |

(*)comparison

AK123QF in samples 1C(*), 4, 5, 7-11 and 12C(*) was used as provided by the supplier.

The powder of copolymer A and copolymer B was sieved with a 200 micron sieve and the powder thus obtained was selected for preparing compositions C1, C2 and C3 as disclosed hereinafter.

Compositions C1 used in samples 2C(*), 3C(*) and 6C(*) were prepared in the form of powder in a standard powder mixer, by pre-mixing AK123QF and the cobalt oxide (if present) and then adding the powder of copolymer A or copolymer B and mixing again.

Compositions C2 were prepared in the form of powder in a standard powder mixer, by pre-mixing the AK123QF and the cobalt oxide (if present) and then adding the powder of copolymer A or copolymer B and mixing again.

Compositions (C3) comprised the powder of copolymer A or of copolymer B only.

Metal panels (measuring 10 mm of side and 3 mm of thickness) were prepared by first cleaning the surface with ethyl alcohol to remove contaminants and then grit blasting the surface with aluminium oxide (10 Mesh), to obtain a roughened surface to achieve a stronger adherence of the primer coating to the substrate.

Then, the panels were pre-heated at 75° C. for 15 minutes, rinsed with H₃ PO₄ 5% w/w and heated at 280° C. for 20 minutes.

### Preparation of Comparison Samples 1C(*), 2C(*), 3C(*) and 6C(*)

Layer (L1) was obtained by spraying compositions C1 as disclosed in Table 1 above, on a metal panel using an electrostatic powder spray gun with output setting of 40 kV and 20 μA. The metal panels thus obtained were heated in an oven at 250° C. for 20 minutes.

Then, layer (L3) was obtained by spraying compositions C3 as disclosed in Table 1 above, by electrostatic spray in the same conditions disclosed for layer (L1), heating the samples thus obtained to a proper temperature and repeating the steps of spraying and heating a second time.

Heating was performed in an oven at 250° C. for 20 minutes for samples 1C(*), 2C(*), 3C(*) and at 260° C. for 20 minutes for sample 6C(*).

The final thickness of layer (L3) was from 200 to 700 μm.

### Preparation of the Samples According to the Present Invention and of Comparison Sample 12C(*)

Layer (L1) was obtained by spraying compositions C1 as disclosed in Table 1 above, on a metal panel by electro powder coating (EPC), using an electrostatic powder spray gun output setting of 40 kV and 20 μA, with a pressure of 2.5 bar.

As soon as spraying of compositions C1 was completed, compositions C2 were sprayed by EPC, using the same apparatus and under the same conditions disclosed above.

Then, the metal panels thus obtained were heated in an oven for a time from 10 to 30 minutes at the processing temperature of the polymers, i.e. 250° C. when copolymer A was used and 260° C. when copolymer B was used.

Metal panels comprising layer (L1) and layer (L2) were thus obtained. The final thickness of layers (L1) and (L2) was from 100 to 800 μm.

Layer (L3) in samples 4, 5, 7 and 8 was obtained by spraying each composition C3, on the metal panels obtained as disclosed above. Spraying was performed by EPC using the same apparatus and under the same conditions disclosed above, heating and repeating the steps of spraying and heating a second time. Heating was performed in an oven at 250° C. for 20 minutes for samples 4 and 5, and at 260° C. for 20 minutes for samples 7 and 8.

The final thickness of layer (L3) was from 200 to 800 μm.

Layer (L3) in samples 9 and 10 was obtained by applying compositions C3 by compression molding as follows.

A plate of copolymer B having a thickness of 1.5 mm was prepared as follows. 40-100 g of copolymer B in form of powder were put within a frame (130×130×1.5 mm). Two aluminium foils were put upon and below to cover the powder in the frame. The frame was then put between two steel plates (200×200×3 mm) and then between the press plates. The press plates were heated at 340-360° C. for 5 minutes. Then, the procedure was as follows: applying pressure (5 ton/4.5 inch), degassing for 1 minute, and applying pressure a second time (16 ton/4.5 inch). Last, a water cooling step was performed to room temperature.

The plate of copolymer B thus obtained and the metal panels obtained as disclosed above were contacted in the press cavity. The cavity of the press was kept at 340° C. for 5 minutes, allowing the plate of copolymer B to melt. Then, the cavity of the press was submitted to a pressure of 75 bar for 2 minutes and subsequently cooled to room temperature by rapid quenching with cooling water.

The final thickness of layer (L3) was from 800 to 1200 μm.

### Example 2—Cathodic Disbonding Test

The cathodic disbonding test was performed in accordance with the CSA—Z 245.20 Canadian Standard.

Layers L1, L2 and L3 (hereinafter referred to as the “coating”) on each sample obtained according to the procedure disclosed in Example 1 above were artificially perforated before starting the test, by drilling a 3 mm diameter hole in the centre of each sample until the metal part was exposed.

An electrical stress was produced by connecting each of the samples to the negative terminal of a source of direct current and by connecting an anode to the positive terminal.

The conditions applied were: 1.5±0.15 V and 65° C.±3° C.

The samples were then cooled to room temperature.

The cathodic disbondment was evaluated 60 minutes after removal of the heat, by cutting with a knife 8 edges of at least 20 mm from the centre of the hole, such that each cut reached the metal panel. Then, the tip of a blade was inserted under the coating at the hole and the coating was chipped off, continuing until the coating showed a definitive resistance.

The distance of chipping was measured from the edge of the original hole along each cut.

To be acceptable, the disbondance distance from the original hole had not to exceed 3 mm after 2 days, 6 mm after 7 days and 12 mm after 28 days.

The results obtained for each sample are summarized in the following Table 2:

TABLE 2

| Sample No. | Results after 2 days | Results after 7 days |
|---|---|---|
| 1C(*) | Not passed | n/p |
| 2C(*) | Not passed | n/p |
| 3C(*) | Not passed | n/p |
| 4 | Passed | Passed |
| 5 | Passed | Passed |
| 6C(*) | Not passed | n/p |
| 7 | Passed | Passed |
| 8 | Passed | Passed |
| 9 | Passed | Passed |
| 10 | Passed | Passed |
| 11 | Passed | Passed |
| 12C(*) | Not passed | n/p |

(*)comparison
n/p: test not performed

The coating in all the comparison samples 1C(*), 2C(*), 3C(*), 6C(*) and 12C(*) was completely detached already after 2 days of treatment, while the coating in the samples according to the present invention met the requirements of the Canadian standard also continued treatment for 7 days.

1. A multi-layered article comprising:
a metal part having at least one surface (S);
a first layer (L1) having a first surface (S1-L1) directly adhered to said surface (S) and a second surface (S2-L1), said layer (L1) being made from a first composition (C1), said composition (C1) comprising at least one epoxy resin (E1);
a second layer (L2) having a first surface (S1-L2) directly adhered to said second surface (S2-L1) of said layer (L1) and a second surface (S2-L2), said layer (L2) being made from a second composition (C2), said composition (C2) comprising at least one epoxy resin (E2) and at least one melt-processable perfluoropolymer [polymer (Pₐ)]
and
optionally, a third layer (L3) having a first surface (S1-L3) directly adhered to said second surface (S2-L2) of said layer (L2), and a second surface (S2-L3), said layer (L3) being made from a third composition (C3), said composition (C3) comprising at least one melt-processable perfluoropolymer.

2. The multi-layered article according to claim 1, wherein said resin (E1) and/or said resin (E2) are prepared by the condensation of epoxy compounds with polyhydric-organic compounds.

3. The multi-layered article according to claim 1, wherein said polymer (Pₐ) and said polymer (P_{b}), identical or different each other, are a polymer comprising recurring units derived from at least one perfluorinated monomer.

4. The multi-layered article according to claim 3, wherein said at least one perfluorinated monomer is selected from the group comprising:
C₂-C₈ perfluoroolefins;
chloro- and/or bromo- and/or iodo-C₂-C₆ fluoroolefins;
CF₂═CFOR_{f1}, wherein R_{f1} is a C₁-C₆ perfluoroalkyl group, or a group of formula —CFOCF₂OR_{f2} wherein R_{f2} is a C₁-C₆ perfluoroalkyl group, a cyclic C₅-C₆ perfluoroalkyl group, or a C₁-C₁₂ (per)fluorooxyalkyl group comprising one or more ether groups;
perfluorodioxoles of formula: 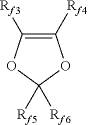
wherein each of R_{f3}, R_{f4}, R_{f5}, R_{f6}, equal of different each other, is independently a fluorine atom, a C₁-C₆ perfluoroalkyl group, optionally comprising one or more oxygen atom.

5. The multi-layered article according to claim 1, wherein said composition (C1) comprises at least one resin (E1) and optionally further ingredients.

6. The multi-layered article according to claim 1, wherein composition (C2) comprises at least one resin (E2), at least one polymer (Pₐ), optionally at least one oxide of cobalt and optionally further ingredients.

7. The multi-layered article according to claim 1, wherein said polymer (Pₐ) comprises one or molar polar functional groups [polymer (Pₐ-F)].

8. The multi-layered article according to claim 7, wherein said one or more polar functional groups are selected from the group consisting of carboxylic groups in acid, acid halide or salt form; sulfonic groups in acid, acid halide or salt form; epoxide groups; silyl groups, alkoxysilane groups; hydroxyl groups; and isocyanate groups.

9. The multi-layered article according to claim 5, wherein said composition (C1) comprises said at least one resin (E1) in an amount of from 5 to 45 wt. % based on the total weight of composition (C1).

10. The multi-layered article according to claim 6, wherein said composition (C2) comprises at least one resin (E2) in an amount of from 0.01 to 20.25 wt. % based on the total weight of composition (C2).

11. The multi-layered article according to claim 6, wherein said composition (C2) comprises polymer (Pₐ) in an amount of from 55 to 99.99 wt. % based on the total weight of composition (C2).

12. The multi-layered article according to claim 6, wherein said composition (C2) comprises said oxide of cobalt in an amount of from 0.05 to 10 wt. % based on the total weight of composition (C2).

13. The multi-layered article according to claim 1, wherein said composition (C3) comprises at least one melt-processable perfluoropolymer [polymer (P_{b})], and optionally further ingredients.

14. The multi-layered article according to claim 13, wherein said composition (C3) comprises polymer (P_{b}) in an amount of from 50 to 100 wt. % based on the total weight of composition (C3).

15. A method comprising the following steps:
applying a first composition (C1), said composition (C1) comprising at least one epoxy resin [resin (E1)], to an article comprising a metal part, said metal part having at least one surface (S) so as to provide a layer (L1) having a first surface (S1-L1) directly adhered to said surface (S), and a second surface (S2-L1);
applying a second composition (C2), said composition (C2) comprising at least one at least one epoxy resin (E2) and at least one melt-processable perfluoropolymer [polymer (Pₐ)], to the article so as to provide a layer (L2) having a first surface (S1-L2) directly adhered to said second surface (S2-L1), and a second surface (S2-L2); and
optionally, applying a third composition (C3), said composition (C3) comprising at least one perfluoropolymer [polymer (P_{b})], to the article so as to provide a layer (L3) having a first surface (S1-L3) directly adhered to said second surface (S2-L2), and a second surface (S2-L3).

16. The method according to claim 15, further comprising applying a fourth composition (C4), said composition (C4) comprising at least one perfluoropolymer [polymer (P_{c})] and optionally further ingredients, to the article so as to provide a layer (L4) having a first surface (S1-L4) directly adhered to said second surface (S2-L3) of said layer (L3).

17. The multi-layered article according to claim 2, wherein the epoxy compounds are selected from epichlorohydrin and glycerol dichlorohydrin and wherein the polyhydric-organic compounds are selected from alcohols, dihydric alcohols, dihydric phenols and trihydric phenols.

18. The multi-layered article according to claim 1, wherein
composition (C1) comprises said at least one resin (E1) in an amount of from 5 to 45 wt. % based on the total weight of composition (C1);
composition (C2) comprises
at least one resin (E2) in an amount of from 0.01 to 20.25 wt. %,
polymer (Pₐ) in an amount of from 55 to 99.99 wt. %, and
an oxide of cobalt in an amount of from 0.05 to 10 wt. %,
each of the above based on the total weight of composition (C2);
composition (C3) comprises polymer (P_{b}) in an amount of from 50 to 100 wt. % based on the total weight of composition (C3);
resin (E1) and/or resin (E2) are each independently prepared by the condensation of at least one epoxy compound selected from epichlorohydrin and glycerol dichlorohydrin with at least one polyhydric-organic compound selected from alcohols; dihydric alcohols; dihydric phenols; and trihydric phenols;
polymer (Pₐ) and polymer (P_{b}), identical or different each other, are a polymer comprising recurring units derived from at least one perfluorinated monomer selected from:
C₂-C₈ perfluoroolefins;
chloro- and/or bromo- and/or iodo-C₂-C₆ fluoroolefins;
CF₂═CFOR_{f1}, wherein R_{f1} is a C₁-C₆ perfluoroalkyl group, or a group of formula —CFOCF₂OR_{f2} wherein R_{f2} is a C₁-C₆ perfluoroalkyl group, a cyclic C₅-C₆ perfluoroalkyl group, or a C₁-C₁₂ (per)fluorooxyalkyl group comprising one or more ether groups;
perfluorodioxoles of formula: 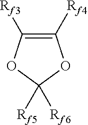
wherein each of R_{f3}, R_{f4}, R_{f5}, R_{f6}, equal of different each other, is independently a fluorine atom, a C₁-C₆ perfluoroalkyl group, optionally comprising one or more oxygen atom; and
polymer (Pₐ) comprises one or molar polar functional groups, each independently selected from the group consisting of carboxylic groups in acid, acid halide or salt form; sulfonic groups in acid, acid halide or salt form; epoxide groups; silyl groups, alkoxysilane groups; hydroxyl groups; and isocyanate groups.
